(19) United States
(12) Patent Application Publication
(10) Pub. No.: US 2012/0024453 A1
(43) Pub. Date: Feb. 2, 2012

(54) STRUCTURE INCLUDING HOLDER UNIT AND DEVICE UNIT AND FIXING METHOD FOR THE SAME

(75) Inventor: Takahisa Kato, Tokyo (JP)

(73) Assignee: CANON KABUSHIKI KAISHA, Tokyo (JP)

(21) Appl. No.: 13/193,395

(22) Filed: Jul. 28, 2011

(30) Foreign Application Priority Data
Aug. 2, 2010 (JP) 2010-173491

(51) Int. Cl. B29C 65/42

(52) U.S. Cl. 156/60; 156/538

(57) ABSTRACT

A structure includes a holder unit including a peripheral portion and a step portion that is higher than the peripheral portion; and a device unit including a bonding portion, an elastic portion, and a support portion that are formed integrally with each other, the support portion being elastically supported with respect to the bonding portion by the elastic portion. The bonding portion is fixed to the peripheral portion of the holder unit. The support portion is caused to contact the step portion by a restoring force of the elastic portion in an elastically deformed state.

### BACKGROUND OF THE INVENTION

1. Field of the Invention

The present invention relates to a structure including a holder unit and a device unit, such as a micro structure made from a wafer by a semiconductor process, and a fixing method for the structure. Here, micro structures are generally fine structures with sizes in the order of millimeters or micrometers, and are used in, for example, actuators, sensors, and structural functional elements including parts having mechanical structures for serving certain functions.

2. Description of the Related Art

Micro structures are generally made from a wafer by a semiconductor process with precision in the order of micrometers, and are used to realize various types of functional elements. Such a micro structure is used in a fixed state in which the micro structure is fixed to a component such as a housing or a holder. The micro structure may be fixed to the holder or the like with, for example, adhesive or solder (see, for example, Japanese Patent Laid-Open Nos. 2009-53633 and 2005-316043).

When the micro structure is fixed to the holder, the fixing strength and the fixing position accuracy may be increased by increasing the area of fixing portions between the micro structure and the holder and intervals between the fixing portions. This is because the bonding area can be increased by increasing the area of the fixing portions, and the fixing strength can be increased accordingly. In addition, when the intervals between the fixing portions are increased, if, for example, the device has a plate shape, an angle error relative to a height error can be reduced. Accordingly, the fixing position accuracy can be increased. In such a case, however, it is necessary to increase the fixing area for the micro structure, and there is a possibility that the number of micro structures that can be manufactured from a single wafer will be reduced.

### SUMMARY OF THE INVENTION

The present invention provides a structure, such as a micro structure, with which the fixing position accuracy and the fixing strength can be increased without increasing the area of the structure, and a fixing method for the structure.

According to an aspect of the present invention, a structure includes a holder unit including a peripheral portion and a step portion that is higher than the peripheral portion; and a device unit including a bonding portion, an elastic portion, and a support portion that are formed integrally with each other, the support portion being elastically supported with respect to the bonding portion by the elastic portion. The bonding portion is fixed to the peripheral portion of the holder unit. The support portion is caused to contact the step portion by a restoring force of the elastic portion in an elastically deformed state.

According to another aspect of the present invention, a fixing method for a structure includes forming a device unit including a bonding portion, a support portion, and an elastic portion from a substrate; forming a holder unit including a peripheral portion and a step portion that is higher than the peripheral portion; adjusting positions of the device unit and the holder unit such that the step portion is capable of contacting the support portion; and fixing the bonding portion to the peripheral portion of the holder unit and causing the support portion to contact the step portion with a restoring force of the elastic portion in an elastically deformed state.

With the structure and the fixing method for the structure according to the aspects of the present invention, the device unit can be fixed to the holder unit such that a portion that provides a fixing strength and a portion that defines a fixing position level, which is a standard fixing position, are separately provided at the bonding portion and the support portion, respectively. Accordingly, the support portion is hardly influenced by deformation or the like of the fixing portions, and the positioning accuracy and the fixing strength with which the device unit is fixed to the holder unit can be increased at the same time.

Further features of the present invention will become apparent from the following description of exemplary embodiments with reference to the attached drawings.

### BRIEF DESCRIPTION OF THE DRAWINGS

FIGS. 1A, 1B, and 1C illustrate a micro structure according to a first embodiment.

FIGS. 2A, 2B, and 2C illustrate a micro structure according to a second embodiment.

FIGS. 3A and 3B illustrate a micro actuator according to a third embodiment.

FIGS. 4A to 4D illustrate a fixing method for a structure according to the present invention.

FIGS. 5A and 5B illustrate a sensor according to a fourth embodiment of the present invention.

### DESCRIPTION OF THE EMBODIMENTS

With a structure and a fixing method according to embodiments of the present invention, a portion of a device unit that provides a fixing strength and a portion of the device unit that defines the fixing position level, which is a standard fixing position, are separately provided at a bonding portion and a support portion, respectively, of the device unit. Accordingly, the support portion can be prevented from being influenced by deformation or the like of fixing portions. The support portion is elastically supported with respect to the bonding portion by an elastic portion that is elastically deformable. When the bonding portion is fixed to a peripheral portion of a holder unit, the elastic portion is elastically deformed and exerts a restoring force that causes the support portion to contact a step portion of the holder unit. Thus, the support portion is fixed to the step portion. Based on this idea, the structure and the fixing method according to the embodiments of the present invention have basic features as described above in the summary of the invention section. In the present invention, the device unit is a unit including a part that serves a certain function. In addition, with regard to the contact state, the support portion may contact the step portion with strength enough to become pressure-bonded to the step portion, or with strength such that the support portion will become separated from the step portion if the bonding portion is released from the fixed state. The contact strength is not particularly limited as long as the support portion does not move with respect to the step portion even when a force equivalent to that applied when the structure serves its function is applied to the support portion in the contact state. The elastic portion is not particularly limited as long as the elastic portion elastically deforms and exerts a restoring force that tries to return the bonding portion and the support portion to original positions thereof when the bonding portion and the support portion are moved relative to each other. For example, the elastic portion is a spring portion that exerts a restoring force, such as tension, when the spring portion is elastically deformed.

Structures and a fixing method for the structures according to embodiments of the present invention will be described with reference to the drawings.

### First Embodiment

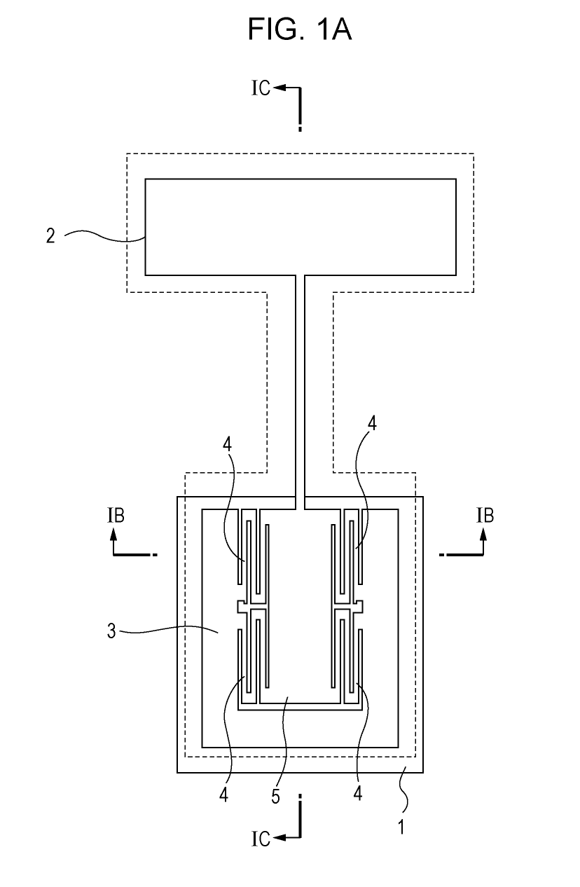

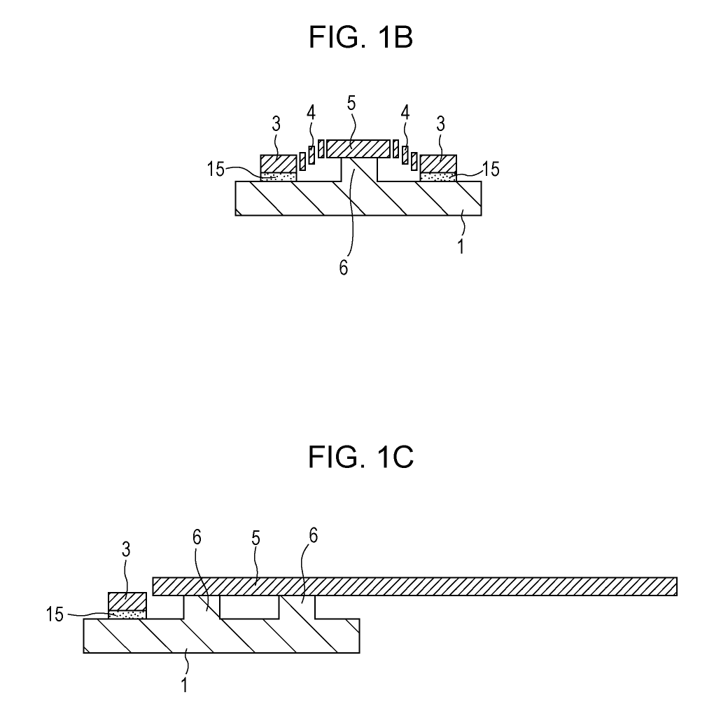

A first embodiment of the present invention will be described with reference to FIGS. 1A, 1B, and 1C. FIG. 1A is a top view of a micro structure, and FIGS. 1B and 1C are sectional views of FIG. 1A taken along lines IB-IB and IC-IC, respectively. As illustrated in FIG. 1A, the micro structure according to the present embodiment includes a holder unit 1 and a device unit 2 that is shown by the area surrounded by dashed lines. The device unit 2 includes a bonding portion 3, spring portions 4, which serves as elastic portions, and a support portion 5. As shown in FIG. 1A, the support portion 5 has a rectangular shape, and the bonding portion 3 surrounds the support portion 5 in an angular-U shape at three sides thereof. The support portion 5 is connected to the bonding portion 3 with the spring portions 4. The spring portions 4 are springs that have an elastically deformable, multiply bent structure with a compliance in a direction perpendicular to the plane of FIG. 1A. The spring portions 4 elastically support the bonding portion 3 and the support portions 5 with respect to each other such that they are movable in this direction (thickness direction). In the example illustrated in FIG. 1A, two spring portions 4 are provided on the left and right sides of the support portion 5. The device unit 2 has an integral structure, and is formed from a single member.

Referring to FIG. 1B, the holder unit 1 includes step portions 6. The step portions 6 have top surfaces that are higher than that of a portion surrounding the step portions 6. The bonding portion 3 is fixed to the holder unit 1 with an adhesive 15, and the support portion 5 is in contact with the step portions 6. Owing to the presence of the step portions 6, the spring portions 4 are stretched and exert a tension or a restoring force that causes the support portion 5 to contact the step portions 6. As illustrated in FIG. 1C, the holder unit 1 includes two step portions 6. The step portions 6 are formed in advance so as to have the same height. Since the support portion 5 is in contact with the step portions 6, the device unit 2 is fixed such that the entire body thereof is accurately positioned at the height of the top surfaces (that is, surfaces in contact with the support portion 5) of the step portions 6.

In the micro structure according to the present embodiment, the bonding portion 3 is fixed to the holder unit 1 with the adhesive 15, so that the spring portions 4 exert the restoring force, such as tension, that presses the support portion 5 against the holder unit 1. Thus, fixing strength for fixing the device unit 2 to the holder unit 1 is provided. In addition, the device unit 2 is positioned at the height of the top surfaces of the step portions 6. Thus, the portion that provides the fixing strength and the portion that defines the fixing position level are separated from each other. Therefore, even when the bonding portion 3 or the adhesive 15 is deformed or the thickness of the adhesive 15 is not uniform, this does not influence the positional relationship between the support portion 5 and the step portions 6. As a result, the device unit 2 can be fixed at the position level defined in advance by the step portions 6 with high accuracy.

The bonding portion 3, the spring portions 4, and the support portion 5 are formed integrally with each other from a single, plate-shaped material. Therefore, it is not necessary to provide regions for connecting these portions to each other, and these portions can be formed in a small region. Accordingly, the device unit can be appropriately fixed without increasing the region occupied by the above-mentioned three portions in the entire region of the device unit. In addition, since the connecting strength and the configuration reliability of the three portions can be increased, the contact reliability between the support portion 5 and the holder unit 1 can be increased. In addition, it is not necessary to use separate components as the spring portions 4 for generating the contact force. Therefore, the number of components can be reduced and the device unit 2 can be fixed with a relatively inexpensive structure. Here, components other than the device unit and the holder unit are not required. Therefore, the fixing structure of the micro structure is relatively inexpensive.

The device unit 2 may be formed from a substrate made of, for example, single crystal silicon, quartz, resin, metal, or ceramic. In particular, single crystal silicon has ideal elastic characteristics and does not cause plastic deformation even when it is largely stretched. Therefore, variation in the contact force due to creeping of the spring portions 4 can be suppressed and the contact reliability of the support portion 5 can be increased. In addition, the spring portions 4 can be largely stretched, so that the contact force of the support portion 5 can be adjusted not only by the shape of the spring portions 4 but also by the height of the step portions 6. Therefore, even when a large contact force is required, the region in which the spring portions 4 are formed can be reduced. Thus, the overall area of the device unit 2 can be reduced.

Instead of using the adhesive 15, the bonding portion 3 may be fixed to the holder unit 1 by, for example, soldering, metal-metal bonding (for example, gold-gold bonding), or anode coupling in accordance with the materials of the holder unit 1 and the bonding portion 3. In any case, the bonding portion 3 and the support portion 5 are mechanically separated from each other by the spring portions 4. Therefore, the support portion 5, which is a standard fixing position, and the step portions 6 are not influenced by deformation of the fixing portions that are fixed together by the adhesive 15 or by shape differences between the fixing portions.

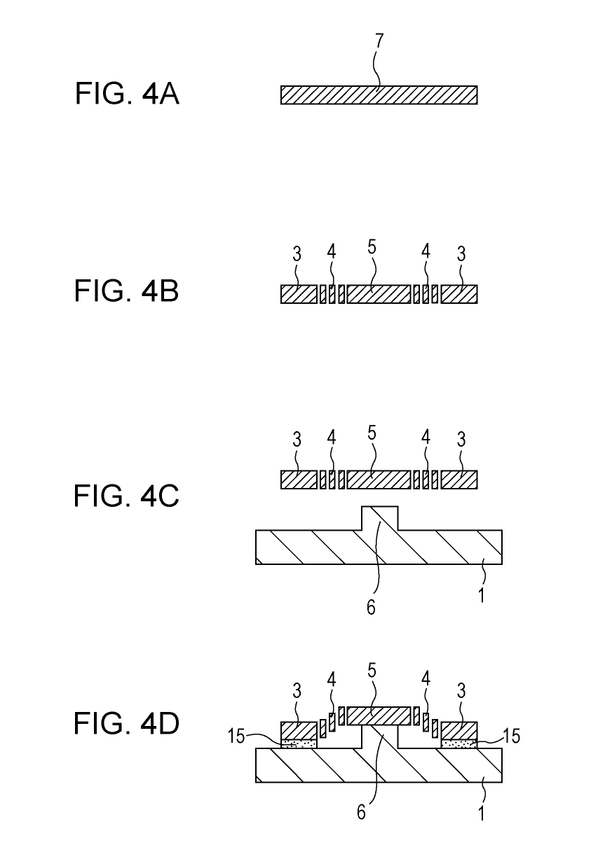

A fixing method for the device unit 2 in the micro structure illustrated in FIG. 1 will now be described with reference to FIGS. 4A to 4D. FIGS. 4A to 4D are sectional views corresponding to FIG. 1B, illustrating steps of the fixing method. As illustrated in FIGS. 4A and 4B, first, a plate-shaped substrate 7 is processed to form the device unit including the bonding portion 3, the spring portions 4, and the support portion 5 that are integrated with each other. When, for example, the substrate 7 is made of single crystal silicon, the device unit can be formed as follows. That is, first, an etching mask is formed by photolithography so as to cover the regions where the bonding portion 3, the spring portions 4, and the support portion 5 are to be formed. Then, through holes are formed in the substrate 7 by silicon dry etching. Next, as illustrated in FIG. 4C, the device portion is positioned with respect to the holder unit 1 such that the support portion 5 can be brought into contact with the step portions 6 in the subsequent step illustrated in FIG. 4D. The holder unit 1 including the step portions 6 is formed in advance by another method. Then, as illustrated in FIG. 4D, the bonding portion 3 is fixed with the adhesive 15 to a portion of the holder unit 1 other than the step portions 6 (that is, a peripheral portion of the step portions 6). At this time, the support portion 5 is caused to contact the step portions 6, as illustrated in FIG. 4D, by the restoring force applied by the spring portions 4 in the elastically deformed state. The device unit 2 included in the micro structure can be fixed to the holder unit 1 by the above-described steps.

Thus, the device unit 2 can be accurately fixed to the holder unit 1 without performing a step of adjusting the fixing position accuracy or precisely controlling the application position and application amount of the adhesive 15. Since the fixing method is simple and includes a single step of forming through holes in the substrate 7 and a single bonding step, the fixing method is relatively inexpensive. In the case where the substrate 7 is formed of single crystal silicon, the bonding portion 3, the spring portions 4, and the support portion 5 having small sizes can be formed next to each other by photolithography and silicon dry etching, as described above. Therefore, the region occupied by the three kinds of components can be reduced, and the region of the device unit 2 can be reduced accordingly. As a result, a large number of device units can be formed from the substrate 7.

### Second Embodiment

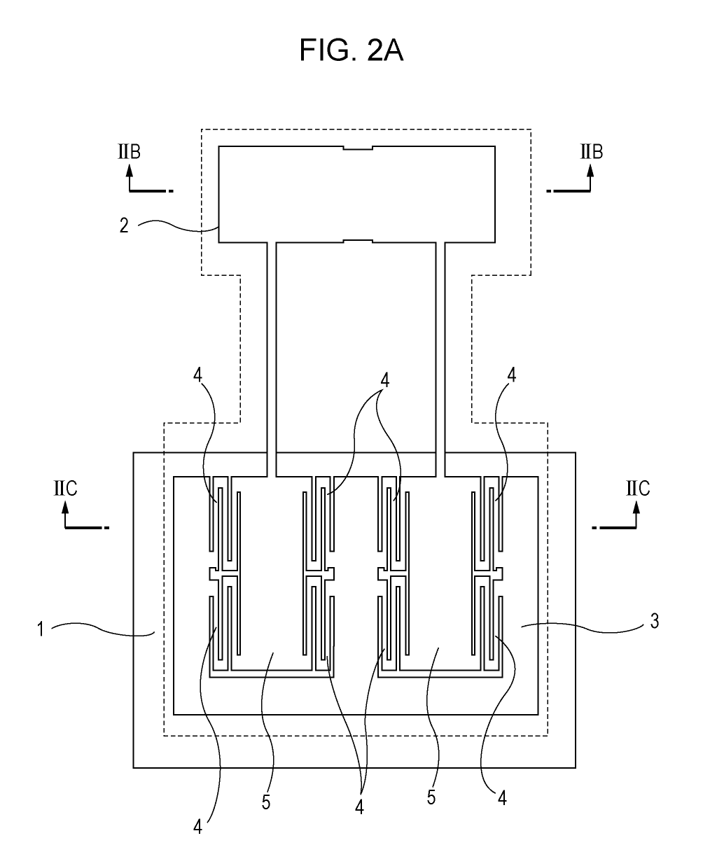

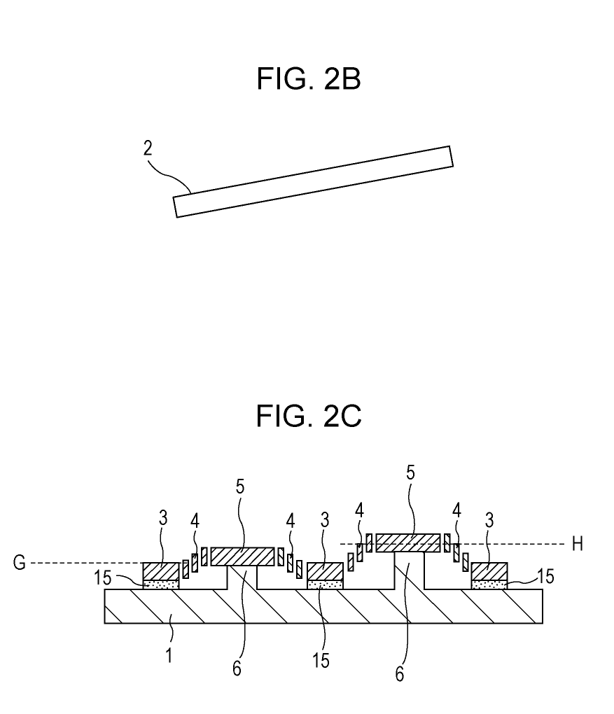

A second embodiment of the present invention will be described with reference to FIGS. 2A, 2B, and 2C. FIG. 2A is a top view of a micro structure according to the present embodiment, and FIGS. 2B and 2C are sectional views of FIG. 2A taken along lines IIB-IIB and IIC-IIC, respectively. Components having the same functions as those of the components of the first embodiment are denoted by the same reference numerals.

Different from the first embodiment, in the micro structure according to the present embodiment, the step portions 6 define two height levels G and H, as illustrated in FIG. 2C. The device unit 2 in the micro structure includes two sets of components, each set including a bonding portion 3, spring portions 4, and a support portion 5. The two support portion 5 are fixed by being in contact with the step portions 6 at the height levels G and H. Thus, two height levels can be provided in the device unit 2. Owing to the difference between the height levels, an end portion of the device unit 2, for example, can be arranged in an inclined manner, as illustrated in FIG. 2B. In the case where different height levels can be provided in a single device unit 2 as described above, the device unit 2 can easily be accurately arranged such that an end portion thereof is inclined or such that end portions thereof are at separate positions with respect to the substrate plane of the holder unit 1. The present embodiment may be applied to, for example, a light reflective mirror in which the inclined portion serves as a reflective surface. Alternatively, a shutter may be formed by using the difference in height level. More specifically, the micro structure according to the present embodiment may be used as a shutter that includes two shielding plates arranged at different heights and that blocks light by driving the shielding plates.

Here, the number of height levels may be more than two. Even in such a case, the fixing process of the structure does not become complex, and the fixing method is simple and relatively inexpensive, similar to that in the case where there is only one height level.

In the micro structure of the present embodiment, a plurality of support portions are in contact with step portions having different height levels. Accordingly, a single device unit including portions arranged at different heights can be provided.

### Third Embodiment

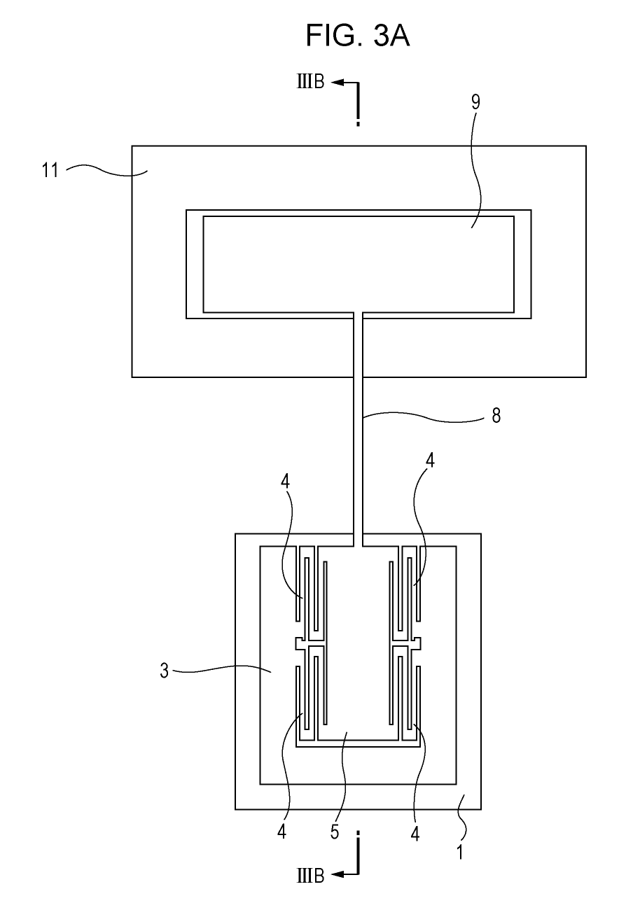

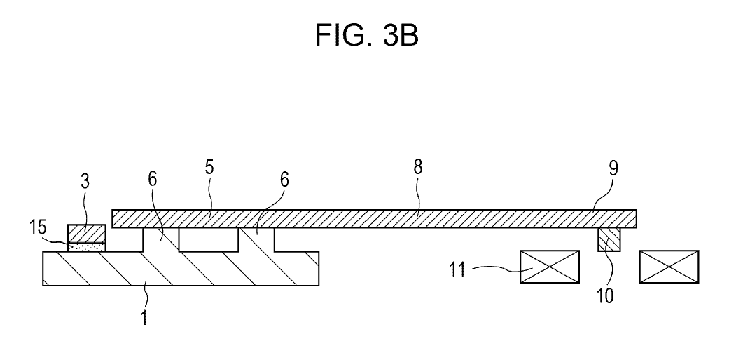

A third embodiment of the present invention will be described with reference to FIGS. 3A and 2B. FIG. 3A is a top view of a micro structure according to the present embodiment, and FIG. 3B is a sectional view of FIG. 3A taken along line IIIB-IIIB. Components having the same functions as those of the components of the above-described embodiments are denoted by the same reference numerals. The micro structure according to the present embodiment is a micro actuator formed by adding, to the micro structure of the first embodiment, a movable portion that is movably supported on the support portion and an actuator portion for driving the movable portion. As illustrated in FIG. 3A, a movable portion 9 is elastically supported with respect to the support portion 5 by a torsion spring 8 in a rotatable manner. As illustrated in FIG. 3B, a permanent magnet 10 is provided on the movable portion 9. A coil 11 is arranged as illustrated in FIGS. 3A and 3B with a gap between the coil 11 and the permanent magnet 10. The permanent magnet 10 and the coil 11 form an actuator portion for driving the movable portion 9. When a current is applied to the coil 11 and a magnetic field is generated, a torque is applied to the permanent magnet 10 and the movable portion 9 is driven accordingly.

A surface of the movable portion 9 on which the permanent magnet 10 is not provided is coated with metal having a high reflectance by vapor deposition. When a laser beam is incident on this surface while the movable portion 9 is driven by the actuator portion (10 and 11), the micro structure functions as a light deflector. For example, the movable portion 9 has a longitudinal width of 3 mm and a lateral width of 0.5 mm, the torsion spring 8 has a width of 80 μm and a length of 3 mm, and the outer shape of the bonding portion 3 has a width of 2 mm and a length of 3 mm. The device unit 2 is formed by etching a single crystal silicon wafer, and has a thickness of 300 μm.

The micro actuator according to the present embodiment is fixed while being accurately positioned at the height of the step portions 6. Therefore, the movable portion 9 in the micro actuator is accurately positioned in the initial state. In addition, the torsional axis of the torsion spring 8 can also be accurately positioned, so that displacement of a locus of the twisting motion can be reduced. Thus, the surface position accuracy and the position accuracy of the axis of motion of the movable portion 9 can be increased. In particular, in the case where the micro actuator is used as a light deflector as in the present embodiment, unexpected tilting of the reflective surface can be reduced, and displacement and tilting of a light scanning axis can also be reduced. In addition, the positional relationship between the permanent magnet 10 and the coil 11 can be accurately adjusted. Accordingly, when a plurality of micro actuators are manufactured, individual differences between torque generation efficiencies of the micro actuators can be reduced. Since the permanent magnet 10 and the coil 11 can be accurately positioned, a high-torque actuator that is relatively inexpensive can be formed by arranging the permanent magnet 10 and the coil 11 near each other.

In the case where the holder unit 1 is mounted in an optical apparatus, there is a possibility that the holder unit 1 will be deformed when it is fixed. However, the stress caused by the deformation is not easily directly transmitted to the support portion 5. Thus, the stability of the surface position accuracy is increased. In addition, the stress is also not easily directly transmitted to the torsion spring 8. Therefore, the spring constant does not easily vary in response to the external stress, and the stability of the driving characteristics of the movable portion 9 can be stabilized.

The above-described light deflector can be used in an optical scanning system in an optical apparatus such as a laser beam printer or a projector. Since the size of the light deflector can be reduced, the size of the optical scanning system can be reduced accordingly. In addition, since the position accuracy of the device unit can be increased, tilting of the reflective surface in a non-driven state and tilting of the torsional axis can be reduced. Accordingly, an adjusting step can be simplified in the assembly of the optical scanning system, and an optical scanning system that is relatively inexpensive can be manufactured. In addition, the weight of the movable portion that performs optical scanning can be reduced, so that the energy of mechanical vibration generated in the scanning process can be reduced. Accordingly, the amount of mechanical vibration that is transmitted to components other than the light deflector can be reduced. Thus, degradation of performance caused when the mechanical vibration is unexpectedly transmitted to components other than the light deflector in the optical scanning system or the optical apparatus can be reduced. In the present embodiment, if different height levels are provided as in the second embodiment, an actuator in which the level difference is utilized can be obtained. In addition, movable portions may be arranged so as to overlap or be disposed at different initial positions.

### Fourth Embodiment

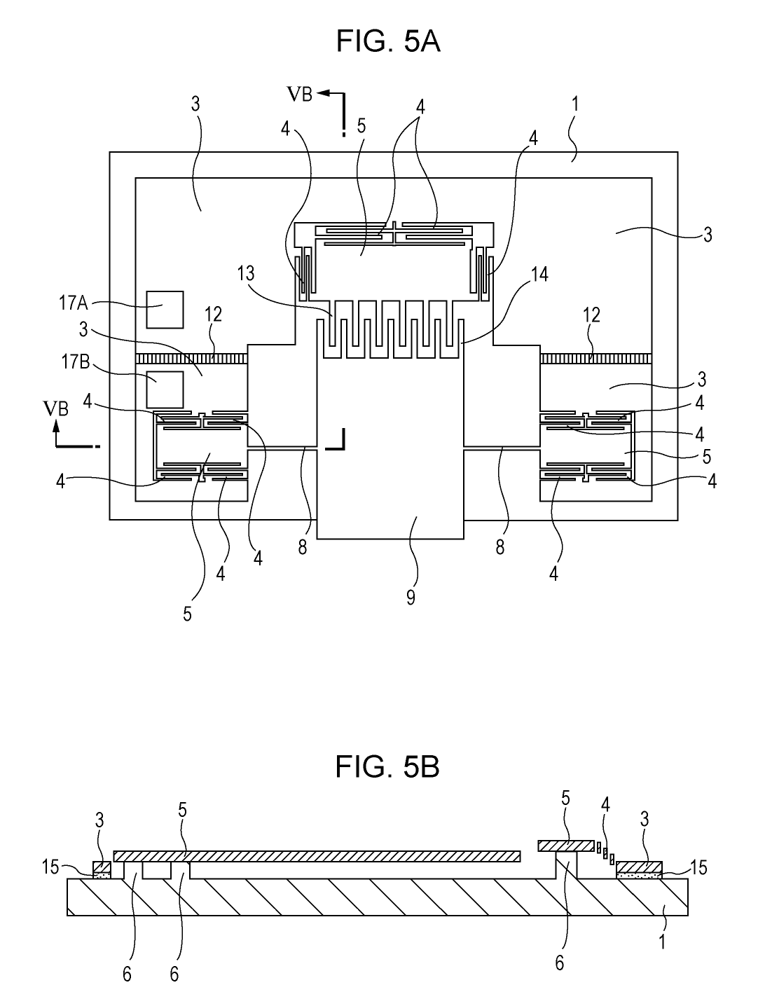

A fourth embodiment of the present invention will be described with reference to FIGS. 5A and 5B. FIG. 5A is a top view of a micro structure according to the present embodiment, and FIG. 5B is a sectional view of FIG. 5A taken along line VB-VB. Components having the same functions as those of the components of the above-described embodiments are denoted by the same reference numerals. In the present embodiment, two height levels are set by the step portions 6, as in the micro structure according to the second embodiment. As illustrated in FIG. 5A, a fixed comb electrode 13 and a movable comb electrode 14 are opposed to each other with a gap therebetween so as to interlock. Support portions 5 to which the fixed comb electrode 13 and the movable comb electrode 14 are connected are supported at different height levels. As illustrated in FIG. 5B, the movable comb electrode 14 is positioned lower than the fixed comb electrode 13. Thus, a step is formed between the fixed comb electrode 13 and the movable comb electrode 14 in a normal direction with respect to the plane of FIG. 5A. The support portions 5 are electrically insulated by insulating portions 12 provided on the bonding portion 3. As illustrated in FIG. 5A, electrode pads 17A and 17B are formed on the bonding portion 3. When the electrode pads 17A and 17B are connected to a power source, a voltage is applied between the fixed comb electrode 13 and the movable comb electrode 14.

The device unit is formed by etching a low-resistance silicon substrate on which the insulating portions 12 are formed in advance. In the present embodiment, the step portions 6 of the holder unit 1 are formed by forming bump structures made of copper plating on the silicon substrate. Since the copper bumps are formed on the holder unit 1, the height levels can be accurately set in the order of micrometers. In addition, when a plurality of height levels are to be provided in a single holder unit 1, height levels having small differences can be formed. In addition, since the components can be formed by photolithography, even when there are a plurality of height levels, the components can be accurately arranged when viewed in a normal direction of the plane of FIG. 5A.

The micro structure according to the present embodiment may be used as an acceleration sensor in which a bias voltage is applied to the electrode pads 17A and 17B and a variation in capacitance between the fixed comb electrode 13 and the movable comb electrode 14 is detected. When an acceleration is applied to the holder unit 1 in the normal direction of the plane of FIG. 5A, the movable portion 9, which functions as a sensor portion that is movably supported by the support portion, rotates around the torsional axis of torsion springs 8. As a result, the capacitance between the movable comb electrode 14 and the fixed comb electrode 13 varies. The acceleration can be measured by detecting the capacitance variation.

In the sensor according to the present embodiment, the movable portion 9 can be accurately positioned in the initial state. Therefore, differences in capacitance between the sensors can be reduced by a relatively simple method. In addition, the capacitance between the comb electrodes having a level difference therebetween in the normal direction of the substrate can be easily obtained. Therefore, a displacement (or a pressure, an acoustic wave, an ultrasonic wave, etc., that can be converted into the displacement of the sensor), an acceleration, an angular velocity, etc., in this direction can be accurately detected. In addition, when the device unit is bonded to the holder unit 1 made of silicon as in the present embodiment, warping due to temperature can be suppressed.

The micro structure according to the present embodiment can also be formed as an actuator by applying a driving voltage between the fixed comb electrode 13 and the movable comb electrode 14. In the case where the micro structure is used as an actuator, a large-stroke electrostatic actuator that generates a force in the normal direction of the plane of FIG. 5A can be manufactured with a relatively low cost. Thus, a relatively inexpensive micro actuator can be manufactured. When different height levels are provided, a capacitance in which the level difference is utilized can be obtained. In addition, movable portions may be arranged so as to overlap or be disposed at different initial positions.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-173491 filed Aug. 2, 2010, which is hereby incorporated by reference herein in its entirety.

What is claimed is:

1. A structure comprising:
a holder unit including a peripheral portion and a step portion that is higher than the peripheral portion; and
a device unit including a bonding portion, an elastic portion, and a support portion that are formed integrally with each other, the support portion being elastically supported with respect to the bonding portion by the elastic portion,
wherein the bonding portion is fixed to the peripheral portion of the holder unit, and
wherein the support portion is caused to contact the step portion by a restoring force of the elastic portion in an elastically deformed state.

2. The structure according to claim 1, wherein the bonding portion, the elastic portion, and the support portion are formed integrally with each other from a single plate-shaped material.

3. The structure according to claim 1, wherein the holder unit includes a plurality of step portions and the device unit includes a plurality of support portions,
wherein the step portions have different height levels with respect to the peripheral portion, and
wherein the support portions are caused to contact the step portions having different height levels.

4. The structure according to claim 1, wherein the device unit includes a movable portion that is movably supported by the support portion and an actuator portion that drives the movable portion.

5. The structure according to claim 1, wherein the device unit includes a sensor portion that is movably supported by the support portion.

6. A fixing method for a structure, comprising:
forming a device unit including a bonding portion, a support portion, and an elastic portion from a substrate;
forming a holder unit including a peripheral portion and a step portion that is higher than the peripheral portion;
adjusting positions of the device unit and the holder unit such that the step portion is capable of contacting the support portion; and
fixing the bonding portion to the peripheral portion of the holder unit and causing the support portion to contact the step portion with a restoring force of the elastic portion in an elastically deformed state.
